(19) United States
(12) Patent Application Publication
(10) Pub. No.: US 2024/0022524 A1
(43) Pub. Date: Jan. 18, 2024

(54) STATION FOR USE IN A FIELD NETWORK BETWEEN ONE OR MORE FIELD DEVICES AND A CENTRAL UNIT, AND SWITCH MODULE BEING EXCHANGEABLE PLUGGABLE INTO A MODULE CARRIER

(71) Applicant: Turck Holding GmbH, Halver (DE)

(72) Inventors: Werner Bibernell, Mülheim (DE); Adalbert Gabrysch, Dorsten (DE)

(21) Appl. No.: 18/351,644

(22) Filed: Jul. 13, 2023

(30) Foreign Application Priority Data
Jul. 15, 2022 (DE) 10 2022 117 693.2

(51) Int. Cl. H04L 49/111; H04L 49/112; H04L 49/351

(52) U.S. Cl. CPC H04L 49/111; H04L 49/112; H04L 49/351

(57) ABSTRACT

A station for use in a field network between at least one field device and a central unit, includes a module carrier and exchangeable pluggable modules thereon, wherein at least one of the exchangeable pluggable modules is designed as a switch module to which the at least one field device is connectable, and wherein optionally, in addition, at least one of the exchangeable pluggable modules is designed as a power supply module, the at least one switch module comprises at least one APL Ethernet port and/or at least one SPE Ethernet port for connecting the at least one field device. Further, a switch module is exchangeably pluggable in a module carrier to which one or more field devices is connectable.

### CROSS REFERENCE TO RELATED APPLICATIONS

This application claims priority to German patent application DE 10 2022 117 693.2 filed on Jul. 15, 2022, which is hereby incorporated by reference in its entirety.

### TECHNICAL FIELD

The present disclosure is in the field of the industrial Internet of Things, and more particularly in the field of an Ethernet communication technology specifically designed to meet the requirements of the process industry. The disclosure relates to a station for use in a field network between at least one field device and a central unit, wherein the station comprises a module carrier and exchangeable pluggable modules thereon, wherein the modules comprise at least one switch module to which the at least one field device is connectable, and wherein the modules optionally additionally comprise at least one or two power supply modules.

A general overview of a system for controlling so-called field devices in the field of process automation is shown in FIG. 6.

Reference symbol 1 indicates so-called field devices (“field devices”). Field devices can be, for example, sensors and/or actuators in automation technology, which use various protocols (4. 20 mA, HART, PA, FF, etc.). These field devices are connected to so-called programmable logic controllers, so-called PLCs 2, by means of measures known per se, for example by means of “10 SPE.” These may comprise a power supply (“power”). The control of, respectively the communication with the field devices 1 is usually performed via an Ethernet standard. The programmable logic controller 2 is, for example, as shown in FIG. 6, connectable via a working network (here: “process network;” uses for instance “PROFINET/Ethernet IP”) via a firewall 3 to an operating network 4 (here: “office network” with the schematically shown connected parts “SCADA,” “engineering,” “asset management”). The field devices 1 are connected to the stored-program control 2 via so-called switches 5 (“switch,” “field switch;” with power supply via “10 SPE 2-wire with power” or separately “power”). In the configuration in FIG. 6 different types of switches are shown, which are provided at different positions in the network.

In FIG. 6 on the lower side, the so-called hazardous area class 0 and hazardous area class 1 are shown, delimited by a dashed line.

The different types of hazardous area classes are typically understood according to the corresponding legal regulations.

Here, hazardous area class 0 is a place in which an explosive atmosphere of a mixture of air with flammable substances in the form of gas, vapor or mist is present continuously or for long periods. Hazardous area class 1 is a place in which an explosive atmosphere of a mixture of air with flammable substances in the form of gas, vapor or mist is likely to occur in normal operation. Hazardous area class 2 is an area in which an explosive atmosphere of a mixture of air with flammable substances in the form of gas, vapor or mist is not likely to occur in normal operation, and if occurring, it will do so only infrequently and only for a short period. In particular, when operating in hazardous area classes 0 and 1, special requirements must be met by the components, for example, to prevent sparks from occurring between two power lines. For example, certain voltages applied to the supply lines must not be exceeded. Other requirements must also be met through classification as “hazardous area class 0 suitable” or “hazardous area class 1 suitable.” Components that meet these requirements are also referred to as “fail-safe.”

In particular, the present disclosure is concerned with a station for use in a field network between one or more field devices and a central unit. This central unit may be the aforementioned stored-program controller. Such stations connected between such a central unit and the field devices are generally known.

### BACKGROUND

For example, WO 2020/233087 A1 describes a so-called field distributor, which is an example of such a station. In this field distributor, the control signals are exchanged with a higher-level central unit via an input module. Connected thereto is a so-called multiplexer, which is connected to several output modules. A corresponding field device is connectable to each of these output modules.

Another known system in which such a station is present is known from EP 1 014 531 A2. There, a signal converter is provided as an example of such a station, which is plugged between the field devices and the central unit. The arrangement described therein corresponds essentially to the arrangement shown in FIGS. 4 and 5. As shown in FIG. 5, the station comprises a metal housing 6 which is provided with an access flap 7. On an underside of the metal housing, feedthroughs 8 are provided through which the corresponding lines can be led into the metal housing 6. A module carrier 9 is provided in the metal housing 6. The module carrier 9 is shown in detail in FIG. 4. On this module carrier 9, various slots are arranged side by side in series. Various modules are pluggable into these slots.

In FIG. 4, the first two modules on the left side are corresponding power supply modules 10. These power supply modules 10 are used to supply power to the corresponding further modules on the module carrier 9. Directly to the right of the two power supply modules 10 in FIG. 4 are two so-called Ethernet gateway modules 11. One of the two Ethernet gateway modules 11 shown in FIG. 4 is slightly pulled out of the module carrier (pulled out of the slot) and therefore protrudes slightly to the rear in the figure, so that a part of the circuit board protruding from a housing part is visible.

These Ethernet gateway modules 11 each comprise a first and second port 21a, 21b, 22a, 22b on their front narrow side, respectively, into which an Ethernet cable is pluggable in order to connect this station to the central unit. From these Ethernet gateway modules 11, the corresponding signal is then introduced into the so-called I/O modules 14. In the present case, 16 such I/O modules are provided. These can be provided with a switch functionality by means of switch modules. Each of these modules comprises four output channels in the example in FIG. 4. Via a plug provided on the rear narrow side of each module in FIG. 4 (not visible in FIG. 4), which is exchangeably plugged into the module carrier 9, the corresponding channels are routed to the corresponding lines in the module carrier 9.

The corresponding channel of the respective I/O module is contacted at the four horizontal slots 26a, 26b, 26c, 26d on top of each other, which are provided below the respective I/O module in FIG. 4. The four channels thus correspond to four ports of the I/O module. Thus, four field devices are connectable to each module. Further details of the design and the exchangeable plug capability are described in EP 1 014 531 A2.

In particular, it is described therein how, on the one hand, the corresponding I/O modules 14 are supplied with voltage via the module carrier 9 and, on the other hand, the corresponding connections serve for a data exchange, so that a data exchange can be carried out between the field devices 1. In addition, there is also a corresponding connection for monitoring and controlling the corresponding I/O modules 14.

An I/O module is referred to as such because a corresponding signal from the field device 1 is routable in (English “in” meaning “I”) and out (English “out” meaning “0”) there.

The I/O modules known in the state of the art usually do not use communication via Ethernet protocols, but provide for an analog connection of field devices, for example via analog 0-20 mA current loops or digital Namur signals.

### SUMMARY

Based on the prior art described above, it is a task of the disclosure to improve such stations, which are known per se, with respect to their usability in the field of industrial networks. To solve this task, a station comprising the features of an independent claim is disclosed.

The station for use in a field network between at least one field device and a central unit comprises a module carrier and exchangeable pluggable modules thereon. The modules comprise at least one switch module to which the at least one field device is connectable. Optionally, the exchangeable pluggable modules additionally comprise at least one or two power supply modules.

The station is characterized in particular by the at least one switch module having at least one APL Ethernet port and/or at least one SPE Ethernet port for connecting the at least one field device.

In particular, it is provided that the switch module comprises multiple APL or SPE Ethernet ports so that multiple field devices are connectable.

When a field device is connected to an APL or SPL Ethernet port, a data connection is established between the field device and the switch module, or another unit can establish a data connection to the connected field device via the switch module. Furthermore, a further electrical connection can optionally be established between the switch module and the connected field device, in particular for an electrical power supply. The power supply can be provided by means of a power supply module of the station. The power supply can also be provided via the data link.

“Ethernet Advanced Physical Layer” (Ethernet-APL), describes a physical layer for Ethernet communication technology that was developed specifically to meet the needs of the process industry. Some reasons for the development of Ethernet-APL were the need for high speed and long-distance communication, the provision of power and communication signals over a single 2-wire cable, and protective measures for fail-safe operation within explosion-hazardous areas.

Part of the widely used Ethernet standard designed specifically for demanding industrial applications, Ethernet-APL provides a high level of robustness for highly reliable operation. Ethernet-APL was developed as the previously missing link, extending unified Ethernet communications to field instrumentation.

Ethernet-APL is a rugged, two-wire, loop-powered Ethernet physical layer that uses 10BASE-T1L plus extensions for installation within the demanding operating conditions and hazardous areas of process plants. It enables direct connection of field devices to Ethernet-based systems, allowing the process industry to benefit from convergence of its OT (operational technology) and IT (information technology) systems.

Ethernet-APL also offers a high degree of robustness for extremely reliable operation. This means that a switch module is installable in a station that is known per se, which operates with the APL Ethernet standard and which therefore comprises corresponding channels for APL Ethernet to which the field devices are connectable. Furthermore, the switch modules can be installed, removed or exchanged during operation, even in a hazardous area class 1 or 2, i.e., in particular in a “fail-safe” manner.

As an alternative to this APL standard, a switch module with SPE Ethernet ports may also be provided in one variant.

The abbreviation SPE stands for Single Pair Ethernet. Different standards such as 802.3 bp (1000Base-T1), 802.3bw (100Base-T1), 802.3cg (10Base-T1) or 802.3ch (Multi-Gig Automotive Ethernet support establishing Ethernet connections over copper cables with only a single twisted pair. Standards exist for speeds from 10 and 100 over 1000 megabits per second up to several gigabits per second. The maximum distances that can be bridged vary between 15, 40 and up to 1000 meters.

The SPE standards are alternatives to the standards commonly used in the LAN sector, such as 100Base-TX or 1000Base-T, which require two or four twisted pairs of a network cable for data transmission. Cable types used for LAN cabling such as Cat-5, Cat-6 or Cat-7 cables with their RJ-45 connectors are thicker, heavier, more expensive and more complex to install compared to the two-wire SPE cables.

Standardized connectors exist especially for SPE, which eliminate the disadvantages of RJ45 connectors, such as unreliable locking or poor protection against dirt and moisture. Since only one pair of wires is available for the transmission of the full-duplex signals, the signals are transmitted simultaneously in both directions on the pair of wires. The signals run in opposite directions in the cable and overlap. The transmitting and receiving units are aware of the signals they transmit themselves and can therefore isolate the received signals from the superimposed overall signal.

In addition to the use of single-pair copper cables, Single Pair Ethernet enables so-called cable sharing. Here, four-pair cabling is used to establish four independent SPE connections via a single cable.

Analogous to Power over Ethernet for LAN cabling, it is also possible with Single Pair Ethernet to supply end devices with the electrical energy required for operation via the copper cable. The Power over Data Line (PoDL, 802.3bu) standard was created for this purpose, which is not compatible with the Power over Ethernet standards and can supply power of up to 50 watts on the end device side.

Single Pair Ethernet enables Ethernet connections with speeds between 10 Mbit/s and several Gbit/s over only a single twisted pair of wires. The usual LAN standards such as 100Base-TX or 1000Base-T, on the other hand, require two or four twisted pairs of wires. SPE is used, for example, in the automotive sector or in industrial automation.

Thus, instead of known I/O modules, a switch module is installable in a station known per se, which works with the SPE Ethernet standard and thus comprises corresponding channels for SPE Ethernet to which the field devices are connectable.

Thus, at least one switch module configured for the APL standard and one switch module configured for the SPE Ethernet are provided, respectively. These modules are exchangeably attachable to the module carrier.

In particular, the station is thereby configured such that at least one of the power supply modules (10a, 10b) can be removed or exchanged without interrupting the operation of the station and the other plugged modules.

In particular, at least two of the exchangeable pluggable modules are designed as power supply modules so that a redundant electrical power supply of the switch modules and, if applicable, further I/O modules is achieved. In particular, the power supply modules can be configured in such a way that one of the power supply modules can be removed or exchanged without interrupting the operation of the station and the other plugged modules. Any necessary repairs or exchange of a power supply module can therefore be carried out during operation. Furthermore, the operation of the plugged modules is not interrupted in this way if one of the power supply modules fails or is removed or pulled out.

In particular, the power per module is grouped in such a way that no excessive power is provided to enable fail-safe operation and to ensure suitability for hazardous area class 1.

This is achievable, for example, by limiting the voltage and/or current of the power supply modules so that no explosion can be triggered by a resulting spark.

According to an advantageous further development of the disclosure, the modules on the module carrier also comprise an Ethernet gateway module via which the switch module is connectable to the central unit. This means that a data connection between the connected field device and the central unit can be established via the switch module and the Ethernet gateway module.

Such an Ethernet gateway module is known per se. For example, this module is also provided exchangeably on the module carrier. Via this Ethernet gateway module, an Ethernet signal with a predetermined standard, for example 100 Base TX or 1000 Base T1, is introducable from the central unit. The signal is then routed from this Ethernet gateway module to the corresponding switch modules, which comprise at least the APL Ethernet port(s) or the SPE Ethernet port(s) on the output side. This Ethernet gateway module can, for example, comprise one or two ports via which an Ethernet connection can be established.

According to an advantageous further development of the disclosure, the station is configured in such a way that the control of the switch module and, at the same time, a data exchange, which is carried out from the field devices via the switch module, is carried out via a bus system. Advantageously, this enables a particularly simple structure.

When exchanging data for the control of the switch module, control data, diagnostic data and similar data for the individual modules are transmittable, for example, via an internal control bus, which can be designed to be redundant, in particular.

Analogously, data transmission for the other exchangeable pluggable modules, for example for their control and/or monitoring, can also be carried out via the bus system.

The bus system, for example, is essentially integrated in the module carrier. The corresponding modules thus comprise connectors or contact surfaces so that the corresponding modules are contactable with the corresponding connections on the module carrier.

In this variant, both the control of the modules themselves and the data exchange to the field devices is carried out via the bus system. The bus system can therefore be used in two ways: On the one hand, data can be transmitted between the individual plugged modules, such as a switch module, and a central unit; on the other hand, communication between the central unit and the connected field devices is also carried out via the bus system.

According to a further example, the station can also be designed in such a way that only the control (or the data transmission for the control) of the switch module or the switch modules and/or further plugged into I/O modules is carried out via the bus system. In order to exchange data with the field devices via the switch modules, an Ethernet connection being separate from the bus system is then provided.

According to an advantageous further development of the disclosure, such a separate Ethernet connection can be established by connecting the switch module to the Ethernet gateway module, for example, via a patch Ethernet cable.

For example, the second port of the Ethernet gateway module can be used for this purpose. The patch Ethernet cable can connect this second port of the Ethernet gateway module with a first port of the switch module.

For example, for the corresponding embodiment, corresponding ports for Ethernet connectors are provided on a front narrow side of the modules (Ethernet gateway module and/or switch module).

Such an Ethernet patch cable can also connect two adjacent switch modules. The switch modules accordingly comprise a first and second port for the corresponding patch Ethernet cables and the corresponding switch modules are connectable in series, for example, and the corresponding Ethernet connection is pulled through the corresponding modules and thus routed in a circle, for example. In such a ring configuration, an Ethernet connection is implemented from the central unit to the first port of the Ethernet gateway module, then from the second port of the Ethernet gateway module via a patch Ethernet cable a connection to the first switch module and further via additional patch cables to the respective next switch module. In this way, several switch modules are connectable in series. In this case, the last of the switch modules connected in series is connected to the central unit again. This is how an Ethernet ring connection is implemented.

The Ethernet ring connection can make it possible, for example, to remove or deactivate or exchange one of the I/O modules connected in this way during operation or to add a new I/O module to the data line. If the data line is interrupted in one direction, the data line is routable in the opposite direction along the now open ring.

In contrast to the described example, in which both the control of the switch module and the data exchange for the communication between the central unit and the connected field devices is carried out via the bus system, in the last described example the Ethernet standard introduced in the Ethernet gateway module is transferrable to the corresponding switch module and converted there into an APL and/or SPE Ethernet standard for the data exchange with the connected field devices.

By connecting several modules, especially several switch modules, in series, a cascadability of the system is achieved. This means that the number of connections can be varied very easily by adding, removing or replacing new switch modules with multiple connections for APL and/or SPE Ethernet. For the fail-safe operated devices, this can also be done during operation.

According to a further development of the disclosure, the module carrier can comprise a backplane via which the modules can be plugged in. Such a backplane has already been described with reference to the prior art EP 1 014 531 A2 cited above.

According to a further variant of the disclosure, a control unit is integrateable into the backplane, via which the control of the switch modules is carried out.

If this is the case, the Ethernet gateway module can be omitted completely, for example, because the control of the switch modules is carried out in this controller. If this controller is integrated into the backplane, the backplane is more than just a type of plug in card, but in itself comprises a control functionality for the plugged switch modules and different backplanes can then be integrated, for example in the housing, for different applications and provided as a station.

According to an advantageous further development of the disclosure, the backplane thus comprises at least two Ethernet ports that are connected to the control unit in order to connect the control unit to the central unit. These ports may have corresponding specifications for the differently known Ethernet standards, in particular specifications for SPE or APL Ethernet.

Similar to the first variant described above, the control unit can exchange data both for controlling the pluggable (switch) modules and for a data connection with the connected field devices via the bus system in the backplane. This bus system is integrated in the backplane, for example, and the bus system can be coupled to the switch module via the corresponding slots.

For example, several switch modules are arranged side by side in the station, each of which is exchangeably plugged into the module carrier. This allows easy cascadability by adding, removing and/or exchanging switch modules connected in series.

How such a switch module may look (for example visually from the outside, respectively its geometry) has already been explained with reference to the prior art in FIGS. 4 and 5. Such a switch module may comprise a housing which has essentially an angular design in the manner of a film or cassette box with corresponding narrow sides connecting the two opposing plate elements forming the housing. On one narrow side, for example, the connectors for connection to the backplane are provided. Then, on the front side opposite to this narrow side, one or two additional Ethernet ports are provided, for example. The general configuration has been described with reference to FIGS. 4 and 5, the disclosure of which is also to be considered for the present disclosure.

According to an advantageous further development of the disclosure, a maximum of 16 such switch modules are provided side by side in the station. If more than 16 switch modules are provided, the power supply modules must have such a high power that, for example, the requirements for use in hazardous area class 1 can no longer be met.

Therefore, the number of switch modules is limited on the upside, because, with the increased power of the power supply modules that are necessary for the power supply, there may then also be sparking when the switch modules are plugged and unplugged and the corresponding station no longer meets the requirements for use in hazardous area class 1.

In particular, the switch modules that are provided side by side all comprise the same design. However, the switch modules can also comprise different designs, so that individual or several of the switch modules described above according to the disclosure (APL Ethernet modules or SPE Ethernet modules) can also be provided in an unconstrained mixture. In particular, I/O modules known per se and described above in relation to the prior art can also be used in an unconstrained sequence.

Further, other exchangeable pluggable modules may be provided.

Such an I/O module advantageously comprises between two and six field device connection ports. In particular, the number is limited to four.

The previously mentioned number is favorable to meet the requirements for use in hazardous area class 1, if necessary.

Such a switch module accordingly comprises a connector with corresponding pins that can be plugged into the slot. From a line arrangement integrated via the backplane, the signals of the corresponding ports can then be transmitted into corresponding output connectors to which the field devices are connectable.

In particular, the station according to the disclosure is configured such that it can be operated in hazardous area class 1.

This means that it can be operated in accordance with the legal regulations in Germany and in Europe in areas in which an explosive atmosphere of air with flammable substances in the form of gas, vapor or mist is likely to occur in normal operation.

According to an ancillary aspect of the disclosure, a corresponding plug-in switch module having a plurality of APL Ethernet ports and SPE Ethernet ports, respectively, is disclosed.

The switch module, which is exchangeably pluggable into a module carrier and to which one or more field devices are connectable, comprises at least two channels for controlling the same via a bus system and one or more APL Ethernet ports and/or one or more SPE Ethernet ports for connection to the field device or one of the several field devices.

Such a module is provided in particular for the station described above and can comprise the features described above or be set up for the various variants of the station described.

In particular, the module can be supplied with electrical power via a bus system of the module carrier.

According to an advantageous further development, the module comprises at least two channels for controlling it via a bus system and one or more APL or SPE Ethernet ports. Furthermore, the switch module can additionally comprise a first and second port via which the switch module is connectable to an Ethernet connection.

In a further development, a first and a second port are also provided, via which the switch module is connectable to an Ethernet connection, via which a data exchange can be carried out between the at least one field device and the central unit via the switch module.

### BRIEF DESCRIPTION OF THE DRAWINGS

Further advantageous examples are described below with reference to the figures. Thereby:

FIG. 1 illustrates a first example of a station according to the disclosure;

FIG. 2 illustrates a second example of a station according to the disclosure;

FIG. 3 illustrates a third example of a station according to the disclosure;

FIGS. 4 and 5 illustrates an example station known in the prior art; and

FIG. 6 illustrates an example process automation system known in the prior art.

### DESCRIPTION OF EXEMPLARY EMBODIMENTS

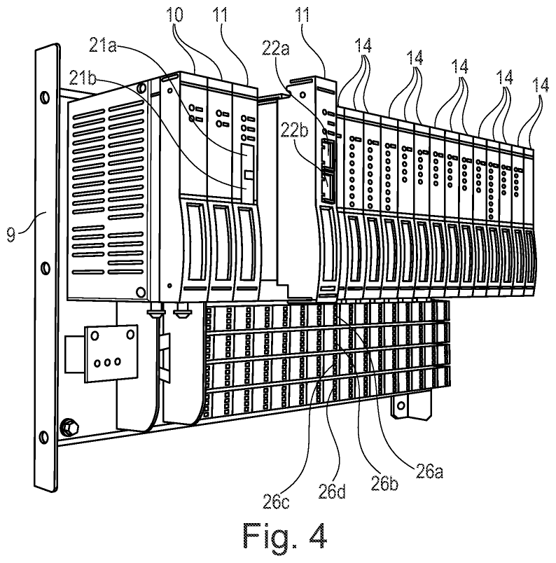

The prior art examples shown in FIGS. 4 to 6 have already been discussed in the introduction and will not be described further below.

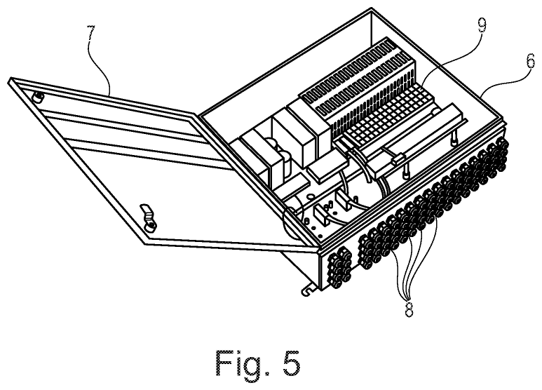

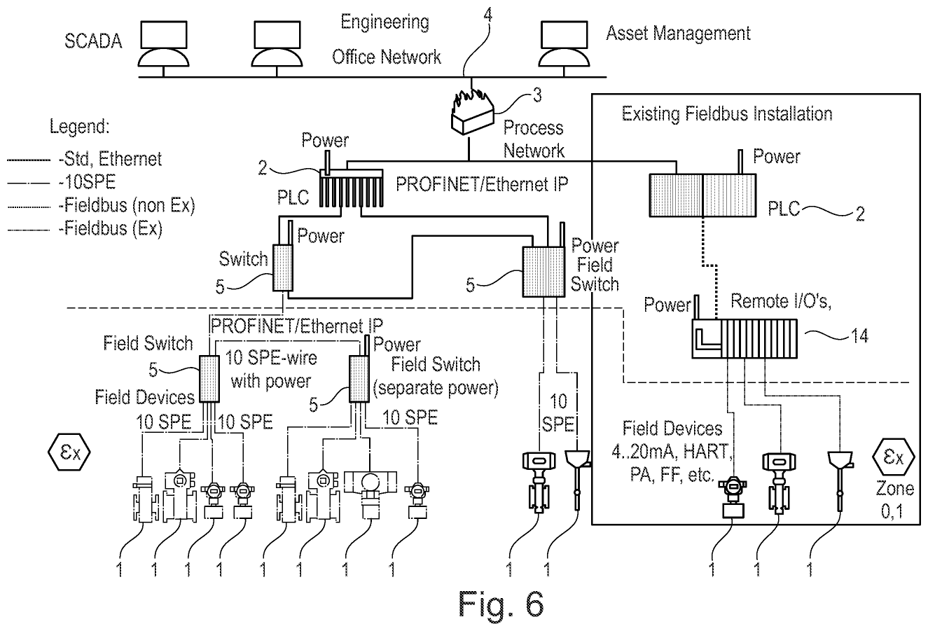

These aspects described for the prior art can also be provided for the present system. That is, the present station is, for example, integrateable into the system as shown in FIG. 6. Also, elements of the station and the IO modules from the station in FIGS. 4 and 5, respectively, can also be incorporated into the present station.

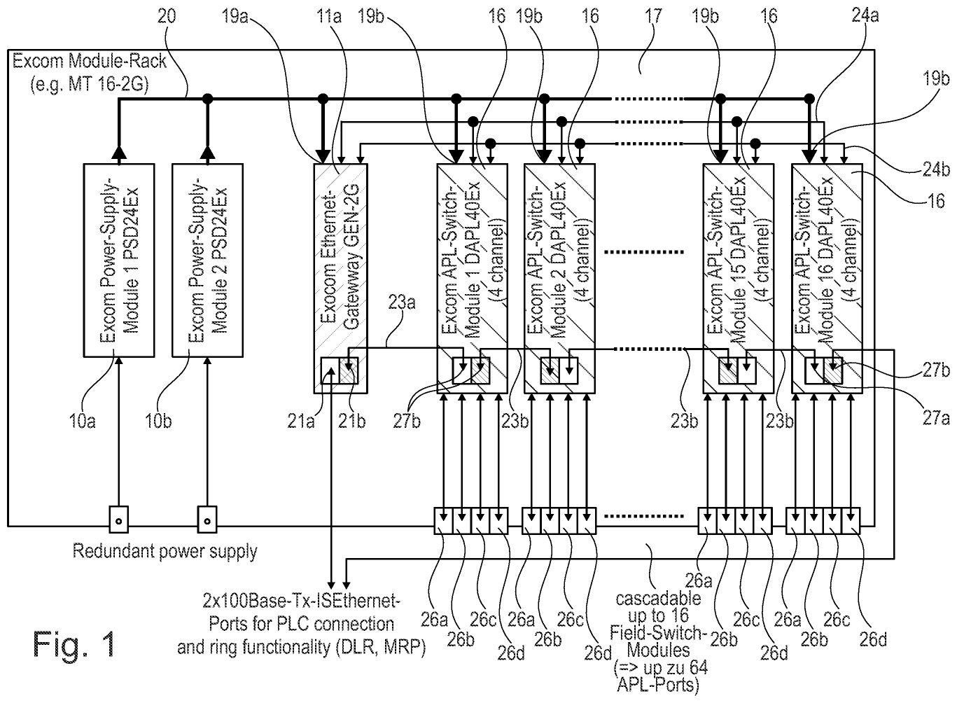

FIGS. 1 to 3 show only schematically the corresponding elements and connections. How the corresponding modules and/or the corresponding station look visually corresponds, for example, to the example shown in FIGS. 4, 5, that is, the corresponding modules can comprise, for example, a cassette-shaped embodiment with a front and rear narrow side. Only the more advanced aspects relevant to the present disclosure will be explained below.

In FIG. 1, reference symbols 10a and 10b denote a first and second power supply module (here: “Excom power supply module 1 PSD24Ex” and “Excom power supply module 2 PSD24Ex”). A redundant power supply (“redundant power supply”) is provided.

Reference symbol 16 indicates the respective switch modules (here: “Excom APL switch modules 1 DAPL40Ex (4 channel)” and “Excom APL switch modules 2 DAPL40Ex (4 channel)” to “Excom APL switch modules 15 DAPL40Ex (4 channel)” and “Excom APL switch modules 16 DAPL40Ex (4 channel)”). These are cascadable up to 16 field switch modules and thus up to 64 APL ports (“cascadable up to 16 Field-Switch-Modules (4 up to 64 APL-ports)”).

Reference character 11a denotes an Ethernet gateway module (here: “Excom Ethernet gateway GEN-2G”).

The corresponding modules 10a, 10b, 11a and 16 are exchangeably plugged into the module carrier designated by the reference symbol 17 (here: “Excom module carrier (e.g., MT 16-2G”).

The module carrier 17 is designed as a so-called backplane. Connectors (not shown in the figure) are provided therein, into which corresponding connectors of the modules are pluggable. For example, the power supply module 10a is connected to connectors on the module carrier via connectors provided on a rear side thereof and not shown. In FIG. 1, the corresponding connectors are not shown. However, they are provided in series side by side from left to right so that the corresponding modules can be plugged side by side in the manner shown in FIG. 4.

Below the switch modules 16, schematically corresponding groups of four provided slots 26a, 26b, 26c, 26d, each for connecting a corresponding field device, are provided. In this example, four such slots 26a, 26b, 26c, 26d are assigned to each switch module 16 in order to be able to connect four field devices accordingly.

Accordingly, each switch module comprises four channels, each of which forms a corresponding port. This port is connected to the module carrier via a plug contact provided on the rear of the corresponding switch module and is connected there via wiring to the corresponding slots 26a, 26b, 26c, 26d for connection to the field devices.

Furthermore, other I/O modules not shown here can be plugged in, for example for communication via an analog 4-20 mA current loop.

With the reference symbols 19a and 19b, connections for the power supply modules are also shown schematically. The power supply modules supply the corresponding further modules, for example Ethernet gateway, I/O and/or switch modules, via the corresponding wiring in the module carrier.

This can be seen schematically in the power supply line (“internal power supply”) designated by reference symbol 20, which is fed to the corresponding modules.

In the example, two power supply modules 10a, 10b are provided by means of which a redundant power supply is implemented. In particular, the power supply of the plugged modules is not interrupted if one of the power supply modules 10a, 10b fails or is removed or pulled out. This enables any necessary repair or exchange during operation.

For example, a 24 volt DC voltage can be supplied (or, for example, a voltage between 18 and 32 volts). This is then supplied to the modules via the power supply modules 10a, 10b. In the example of FIG. 1, the Ethernet gateway module 11a comprises a first port 21a and a second port 21b through which the Ethernet gateway module 11a is connectable to an Ethernet.

The first port 21a is used to connect the Ethernet gateway module 11a to a central unit not shown in the figure. The second port 21b is used to connect the Ethernet gateway module 11a to the corresponding switch modules 16. Each of the switch modules 16 also comprises a first port 27a and a second port 27b. An Ethernet patch cable 23a is provided between the second port 21b of the Ethernet gateway module 11a and the first port 27a of the switch module 16. The corresponding adjacent switch modules 16 are each connected to each other in an analog manner via the Ethernet patch cables 23b.

Thus, in each case, an Ethernet patch cable 23b is fed out of the second Ethernet port 27b of the corresponding switch module 16 and is fed into the first port 27a of the corresponding adjacent switch module 16.

In the present example, the last switch module shown in the row from left to right in the figure is connected to the central unit with its second port 27b (“2×100Base-Tx-ISEthernet-Ports for PLC connection and ring functionality (DLR, MRP)”). Thus, a so-called Ethernet ring is formed. The data exchange of the data from the field devices is carried out via this ring-shaped Ethernet connection. In other examples, a structure deviating from the ring configuration can be provided.

In the present example, the control of the corresponding switch modules is designed separately. This control is formed by the two-channel bus system 24a, 24b. On the one hand, control signals are transmittable to the switch modules via this bus system 24a, 24b, and on the other hand, operating data can be provided by the switch modules, for example.

Thus, the Ethernet gateway module 11 and also the corresponding switch modules 16 comprise corresponding plug connections with which they are connectable to the module carrier. A corresponding wiring for the corresponding two-channel bus system 24a, 24b is to be provided in the module carrier.

Thus, the control of the switch modules is separated from the data transmission to or from the field devices connected to the switch modules.

Each of the switch modules 16 therefore comprises two channels for an Ethernet connection (to the Ethernet gateway module, to the central unit or to the neighboring switch modules) in this example. Two channels are provided for a bus connection to control the switch module and four channels for corresponding data transfers to the connected field devices.

In this example, the corresponding switch module is designed in such a way that the four channels are configured as APL Ethernet channels. Exactly four APL outputs or SPE ports are provided for each of the switch modules. If several ports are provided, this could lead to such a large power consumption that the station could then no longer be used in hazardous area class 1.

In further examples, fewer than four APL outputs may be provided. In further examples, more outputs may further be provided, and optionally further measures may be provided to limit the electrical power that can be output.

In addition, up to 16 such switch modules 16 are provided side by side.

Less than 16 switch modules can also be provided side by side, and any number between 2 and 15 can in itself form an upper or lower limit. In further examples, more switch modules 16 may further be connectable in series, and optionally further measures may be provided to limit the electrical power that can be output.

In the present case, communication between the central unit is carried out via the Ethernet gateway module 11a and between the corresponding switch modules via 100 Base TX Ethernet standard. In principle, any other Ethernet standard can be used.

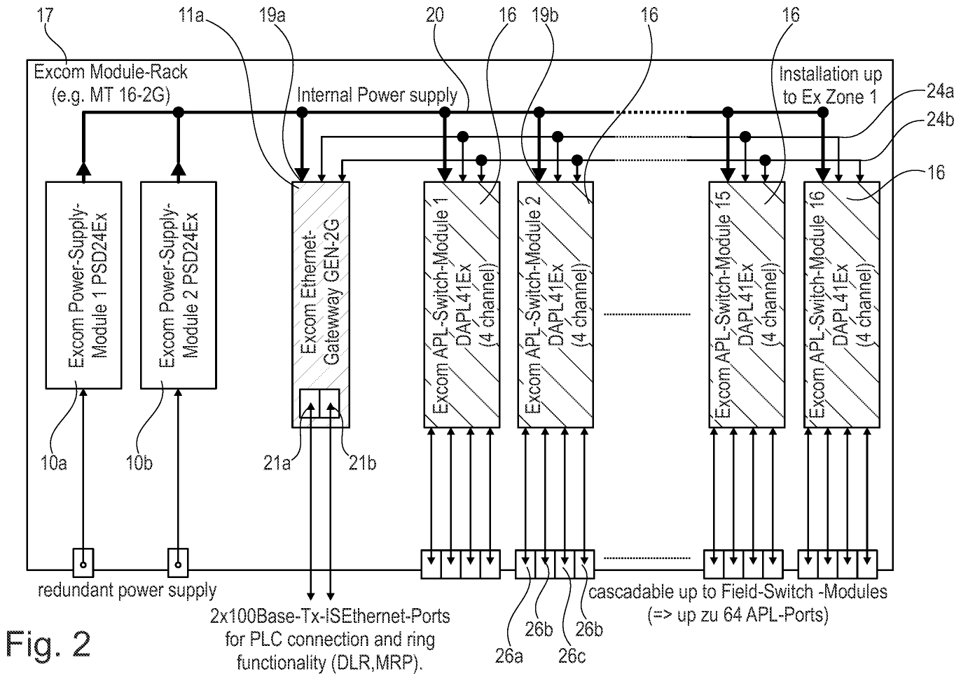

FIG. 2 describes a second example. The same elements with the same reference symbols are used there.

Only the differences to the example in FIG. 1 are described below.

In the example in FIG. 2, both the control of the switch modules 16 (here: “Excom APL switch modules 1 DAPL41Ex (4 channel)” and “Excom APL switch modules 2 DAPL41Ex (4 channel)” to “Excom APL switch modules 15 DAPL41Ex (4 channel)” and “Excom APL switch modules 16 DAPL41Ex (4 channel)”). These are cascadable up to 16 field switch modules and thus up to 64 APL ports (“cascadable up to 16 Field-Switch-Modules (→up to 64 APL-ports)”) as well as the data transfer for the connected field devices is implemented via the bus system 24a, 24b.

Therefore, the corresponding Ethernet patch cables as shown in FIG. 1 are not provided there to connect the switch modules connected in series with each other data-wise. The Ethernet gateway module 11a (here: “Excom Ethernet gateway GEN-2G”), on the other hand, is connected to the central unit with its first port 21a and second port 21b. The switch modules 16 accordingly do not comprise the ports 27a, 27b of the first example.

Thus, in this example, the Ethernet gateway module 11a is configured to transform and/or distribute the corresponding signals.

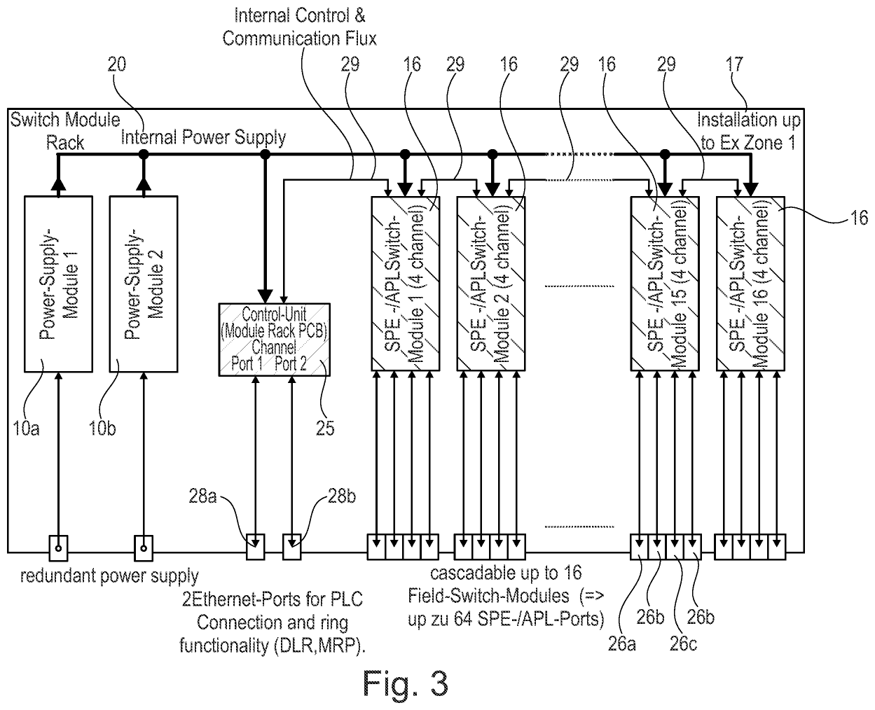

In the example in FIG. 3, the same or comparable elements are also provided with the same reference symbols as in FIGS. 1 and 2 explained above.

Only the differences with respect to the examples in FIGS. 1 and 2 are described.

A redundant power supply is again provided by the power supply modules (“redundant power supply”) designated with reference symbols 10a and 10b (here: “power supply modules 1” and “power supply modules 2”).

Instead of the Ethernet gateway module 11a, which is provided as a plug module, a control unit (here: “Control Unit (Module carrier PCB) Channel Port 1 and Port 2”) is provided in this example. This control unit 25 is integrated in the module carrier 17 (“Switch Module carrier,” “Installation up to hazardous area class 1”), i.e., in the backplane.

In addition to the plug connections via which the modules are connectable to the backplane, the corresponding control unit 25 is integrated in the backplane. This control unit 25 is thus permanently connected to the corresponding further slots of the power supply modules and the switch modules 16, respectively, via the lines integrated in the backplane.

The control unit 25 may comprise corresponding ports connected to a corresponding slot.

In FIG. 3, reference symbols 28a, and 28b show a first and a second port (in the form of a connector) via which an Ethernet cable is connectable to the station from the central unit and from a higher-level control unit, respectively. These ports are provided on the module support 17. A connection to two Ethernet ports is provided, whereby a ring configuration is also made possible (“2 Ethernet Ports for PLC Connection and ring functionality (DLR, MRP)”).

In the first and second examples, the switch modules are APL switch modules. Either APL or SPE switch modules or switch modules of different types can be provided.

The switch modules shown here also comprise four ports in the present example. More or fewer ports can also be provided.

The corresponding switch modules 16 (here: “SPE/APL switch modules 1 (4 channel)” and “SPE/APL switch modules 2 (4 channel)” to “SPE/APL switch modules 15 (4 channel)” and “SPE/APL switch modules 16 (4 channel)”) are controlled via the control unit 25. In addition, a data transmission via these switch modules to the field devices is also carried out via this connection.

These switch modules 16 are also cascadable up to 16 field switch modules and thus up to 64 APL ports Ports (“cascadable up to 16 Field-Switch-Modules (→up to 64 APL-ports)”).

This is shown schematically by the arrows with reference symbol 29 (“Internal Control and Communication Flux”) in the figure.

Insofar as the switch modules are the SPE modules, they are often not suitable for use in hazardous area classes 1 or 2. The third example thus describes a station in which a control device integrated into the backplane is provided.

Looking again at the system shown in FIG. 6, one aspect of how the disclosure can be used can be illustrated: The remote I/O system 14 shown on the right in an area outside the hazardous area class can now be moved into the hazardous area class and additionally equipped with a switch module. Such a remote I/O system 14 is then connected to the PLC 2 outside the hazardous area class via an Ex-capable fieldbus and in turn allows the connection of several field devices, among others via SPE or APL.

The disclosure allows for easy cascadability of the system, as switch modules can be easily added, removed or exchanged to connect one or more field devices, even while the system is in operation.

The control of the power supply modules ensures that enough power is provided for individual switch modules or the individual connected field devices to guarantee fail-safe operation.

Furthermore, the switch modules can be running, removed, exchanged or extended in a fail-safe manner while the system is in operation.

Furthermore, the disclosure allows for high redundancy of important elements, especially the duplicated power supply modules.

The disclosure also enables a step-by-step conversion of systems, for example in process technology. In a mixed configuration, both switch modules for connecting SPE or APL-capable field devices and I/O modules for connecting other field devices are provided at a station. Therefore, new field devices with SPE or APL can be integrated step by step, while the existing other field devices can still be used.

### LIST OF REFERENCE SYMBOLS

1 field devices
2 programmable logic controller, PLC
3 firewall
4 operating network
5 switches
6 metal housing
7 access flap
8 feedthrough
9 module support
10, 10a, 10b power supply module
11, 11a Ethernet gateway module
14 remote I/O system
16 switch module
17 module support
19a, b connection for the corresponding power supply modules
20 power supply line
21a, 22a first port Ethernet gateway module
21b, 22b second port Ethernet gateway module
23a, 23b Ethernet patch cable
24a, 24b bus system
25 control unit
26a, b, c, d slot, field device connection
27a first port switch module
27b second port switch module
28a first port of the control unit
28b second port of the control unit
29 communication and data exchange channel

1. A station for use in a field network between at least one field device and a central unit, the station comprising a module carrier and exchangeable pluggable modules thereon; wherein
at least one of the exchangeable pluggable modules is designed as a switch module to which the at least one field device is connectable, and wherein
optionally, in addition, at least one of the exchangeable pluggable modules is designed as a power supply module, wherein
the at least one switch module comprises at least one APL Ethernet port and/or at least one SPE Ethernet port for connecting the at least one field device.

2. The station according to claim 1, wherein furthermore at least one of the exchangeable pluggable modules is designed as an Ethernet gateway module, via which the switch module is connectable to the central unit.

3. The station according to claim 1, wherein at least two of the exchangeable pluggable modules are designed as power supply modules and are configured such that one of the power supply modules is removable or exchangeable without interrupting an operation of the station and other exchangeable pluggable modules.

4. The station according to claim 1, wherein the station is configured in such a way that a control of the switch module and a data exchange via the switch module with the field device or devices is carried out via a bus system.

5. The station according to claim 1, wherein the station is configured in such a way that a control of the switch module is carried out via a bus system and data exchange via the switch module with the field device(s) is carried out via an Ethernet connection being separate from the bus system.

6. The station of claim 5, wherein the separate Ethernet connection is a patch Ethernet cable connecting a second port of a Ethernet gateway module to a first port of the switch module.

7. The station according to claim 6, wherein the switch module comprises a second port via which it is connected to a further switch module of a same station.

8. The station according to claim 6, wherein the separate Ethernet connection is designed as a ring connection in which a plurality of switch modules of a same station are connected to one another and a last of the switch modules being arranged in series comprises a port via which the station is connected to the central unit and the central unit is also connected to a first port of the Ethernet gateway module.

9. The station according to claim 1, wherein the module carrier comprises a backplane into which the modules can be plugged-in; wherein optionally a control unit is integrated in the backplane, via which a control of the switch module can be carried out.

10. The station according to claim 9, wherein the backplane comprises at least two Ethernet ports with which the control unit is connectable to the central unit.

11. The station according to claim 9, wherein the control unit is configured in such a way that a control of the switch module and a data exchange via the switch module with the field device(s) are carried out via a bus system.

12. The station according to claim 1, wherein: a plurality of switch modules are provided side by side in the station which are exchangeable plugged in the module carrier; and/or
a maximum of 16 switch modules are provided side by side in the station, wherein the plurality of switch modules are optionally designed as switch modules of a same design or of different designs; and/or
the switch module comprises between two and six field device connection ports via each of which a field device is connectable.

13. The station according to claim 1, wherein the station is configured in such a way that it can be used in an explosive atmosphere, optionally in an hazardous area class 1.

14. A switch module being exchangeably pluggable into a module carrier, to which one or more field devices can be connected, having at least two channels for controlling the switch module via a bus system and one or more APL Ethernet ports and/or one or more SPE Ethernet ports for connection to a field device.

15. The switch module according to claim 14, wherein, in addition a first and a second port are provided via which the switch module is connectable to an Ethernet connection via which a data exchange via the switch module can be carried out between the field device(s) and a central unit.
